(19) United States
(12) Patent Application Publication
(10) Pub. No.: US 2004/0264292 A1
(43) Pub. Date: Dec. 30, 2004

(54) Barge-mounted concrete mixing system

(75) Inventors: Thomas J. Harris, Byron, MN (US); Ronald E. Christenson, Parson, TN (US); Ted M. Daly, Kasson, MN (US); Gregory P. Dantzman, Owatonna, MN (US); Tracy L. Timmerman, Dodge Center, MN (US)

Correspondence Address: NIKOLAI & MERSEREAU, P.A., 900 SECOND AVENUE SOUTH, SUITE 820, MINNEAPOLIS, MN, 55402, US

(73) Assignee: McNeilus Truck and Manufacturing, Inc., Dodge Center, MN

(21) Appl. No.: 10/607,883

(22) Filed: Jun. 27, 2003

(51) Int. Cl. B28C 7/16

(52) U.S. Cl. 366/14; 366/43

(57) ABSTRACT

A vessel-mounted concrete mixing system is disclosed that includes a barge having a deck elevated above the water line, at least one rotary mixing drum mounted on the deck to receive, mix and discharge concrete batch ingredients and a conveyor system for conveying mixed concrete batch material discharged from one or more rotary mixing drums, the conveyor system conveying the discharge mixed concrete to a portion of the barge accessible by an off-loading device not mounted on the barge.

### BACKGROUND OF THE INVENTION

I. Field of the Invention

The present invention is directed generally to the delivery of mixed concrete products to pour sites, particularly, to the delivery of mixed concrete via water craft or vessel and, more particularly, to an integrated barge-mounted mixing and delivery system.

II. Related Art

It is known to deliver “ready-mixed” concrete from batching plants to job sites on land using vehicle-mounted transit mixers in which the mixed concrete can be off loaded via chutes into forms, buckets or via pumps to pour sites not directly accessible by truck. It is also known to use a surface platform, which may be floating, to place fresh concrete on the sea floor or other underwater location using piping or similar delivery systems. One such system is illustrated and described by Rail et al in U.S. Pat. No. 4,266,889.

Many on shore or off shore pour sites are difficult to access by conventional truck delivery, however. For these, there remains a need to supply freshly mixed concrete at pour sites in a more convenient manner. Access by water would be particularly desirable.

### SUMMARY OF THE INVENTION

By means of the present invention, there is provided a floating source of freshly mixed concrete, including a system for mixing and dispensing concrete products which enables on-water access to many pour sites where the supplied concrete can be off loaded in conjunction with equipment at the site.

In a detailed embodiment used to illustrate the inventive concept, a conventional barge is provided which may be tug-operated or self-propelled. A pair of large opposed concrete mixing drums are centrally mounted on the barge with facing charge/discharge openings having discharge chute systems which address a common discharge conveyor through a feed hopper which, in turn, delivers mixed open concrete material to an output conveyor from which mixed concrete is delivered to an elevated output chute where is may be off loaded into crane-operated buckets or other off-loading devices. The operation of the system may be controlled remotely from an elevated control room also mounted on the barge.

### BRIEF DESCRIPTION OF THE DRAWINGS

In the drawings, wherein like numerals are utilized to depict like parts throughout the same:

FIG. 1 is a plan view of a barge-mounted concrete mixing system in accordance with the invention;

FIG. 2 is an elevational view partially in section, taken substantially along lines 2-2 of FIG. 1 not including the mixing drum;

FIG. 3 is an elevational view partially in section, taken substantially along lines 3-3 of FIG. 1;

FIG. 4 is a view partially in section, taken substantially along lines 4-4 of FIG. 1; and

FIG. 5 is an enlarged side elevational view depicting one mixing drum.

### DETAILED DESCRIPTION

The embodiment illustrated and described in the detailed description of this specification is intended to serve as an example only and is not intended to limit the scope of the inventive concept in any way. The features of the invention may be manifested in a variety of forms and variations which yet remain within the confines of the intended scope of the invention. With this in mind, a detailed embodiment will next be described.

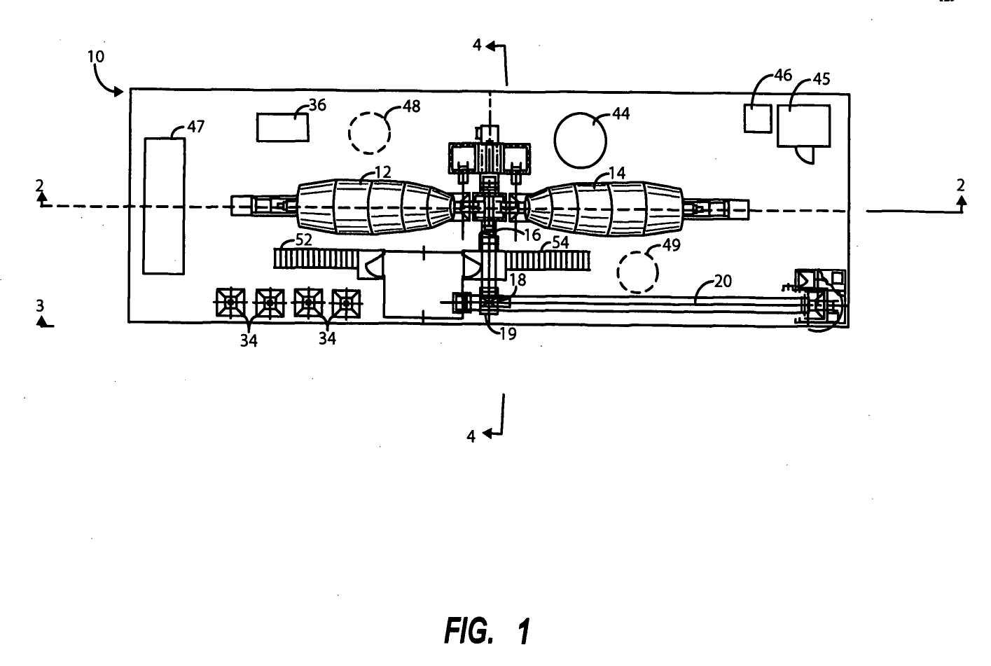

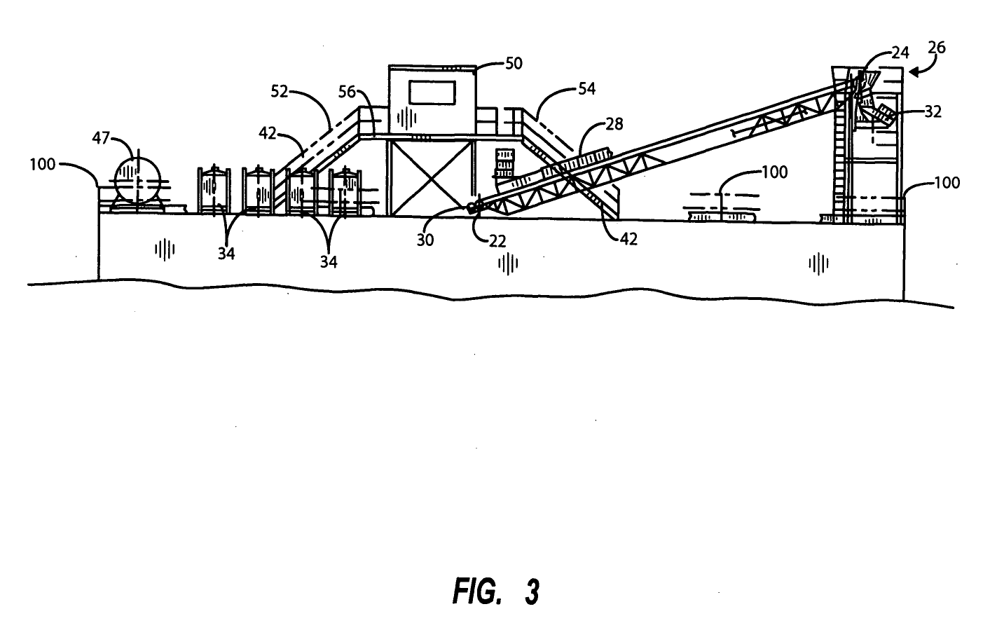

FIG. 1 depicts a top or plan view of one possible arrangement of a barge-mounted concrete mixing system, generally at 10, in accordance with the present invention. The system includes a pair of large opposed mixing drums 12 and 14 of possibly 20 yards or greater capacity mounted on respective mixer bases 13, and 15 to address and discharge mixed material onto a common relatively level discharge conveyor 16 with cover 17 which, in turn, at a head pulley or drive end 18, discharges conveyed material through a further chute 19, on to an inclined product conveyor 20 which has a tail or idler pulley system 22 and a head or drive pulley system 24 as best seen in the elevational view of FIG. 3. The upper portion of the conveyor 20 is supported from a raised platform 26. A partial, hinged conveyor cover is shown at 28 and a conveyor take up system for belt tension adjustment is shown at 30.

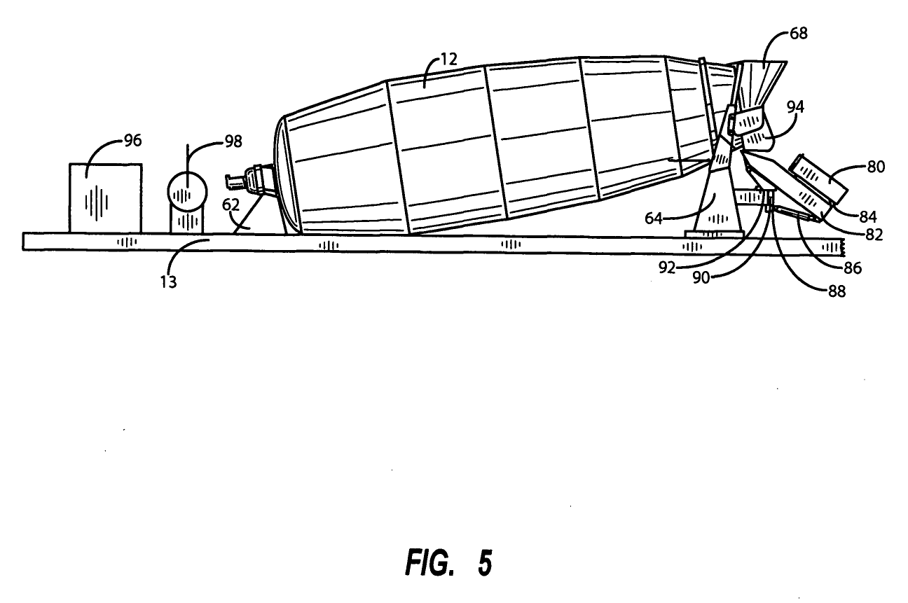

A rotatable, folding discharge chute system 32 for controlling the off loading distribution of mixed concrete is also mounted from the platform 26. The chute may be provided with a mechanized rotating and unfolding system similar to the discharge chutes from the opposed mixing drums as will be described in greater detail in conjunction with FIG. 5. Such systems are known to those in the art and may include manual and automatic control drives, clutches and locking mechanisms.

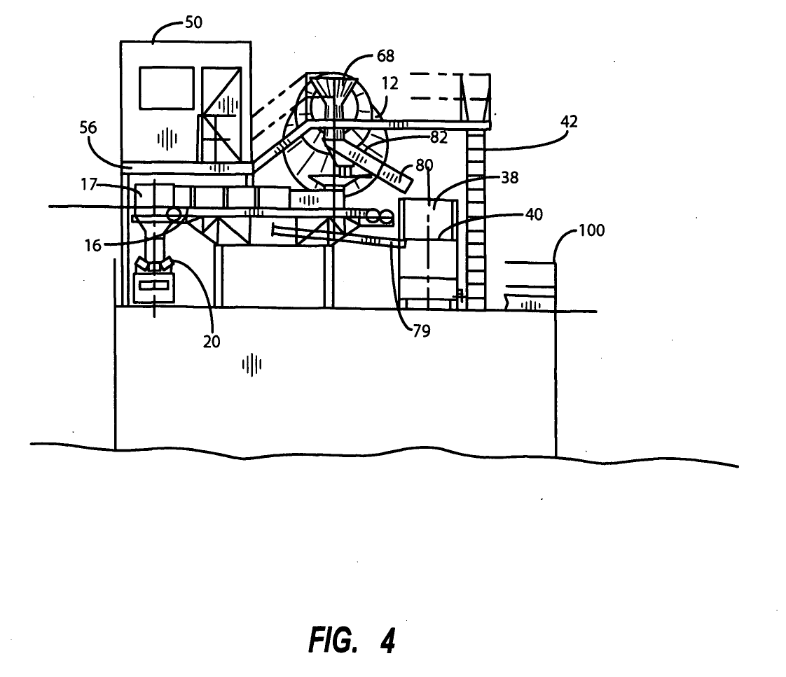

A variety of additive totes or bins are shown at 34 mounted on the deck of the barge to provide additives for concrete batches as needed. Automated or manual access may be provided. A generator is depicted at 36. Also shown in FIG. 1 as being above deck are a recycle or a gray water sump 38 with a recycle water basket strainer 40 (FIG. 4). Also in FIG. 4, an access or service ladder is shown at 42. A gray water storage tank is shown at 44 in FIG. 1 along with a large tool shed 45 and a portable restroom facility 46. Also, below deck, fuel storage tank 48 and potable water storage tank 49 are shown in broken lines. A large liquid nitrogen storage tank is shown at 47. Liquid nitrogen is used for cooling fresh concrete if necessary.

An elevated control room 50 is provided from which the operation of the barge-mounted mixing system may be observed and centrally controlled. The various motors, pumps, valve, cylinders, etc., of the process are preferably integrated and sequenced using as much automatic control as is practical. The control room is provided with accesses in the form of a pair of opposed stairways 52, 54 (FIG. 1). The control room is mounted on an elevated platform 56.

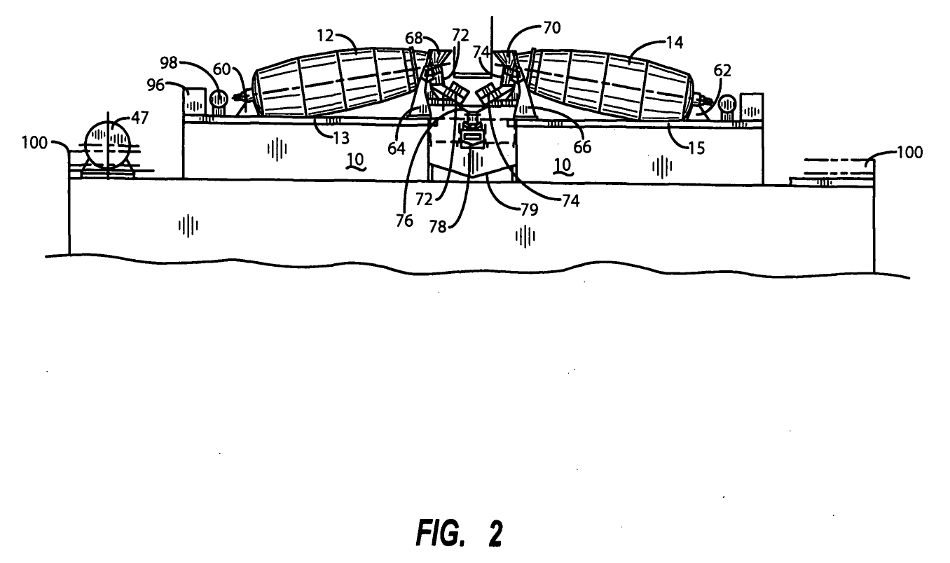

As best seen in FIGS. 2 and 5, the mixing drums 12 and 14 are mounted for rotation in a conventional manner supported by respective drive and support pedestals 60 and 62 and loading/discharge pedestal 64 and 66. The drums are provided with loading or charging chutes at 68 and 70 and rotating and folding mechanized discharge chute systems at 72, 74. As best seen in FIG. 2, conveyor feed hopper 76 is provided above the conveyor 16 and a drip pan 78 which drains into the gray water sump 38 at 79 (FIG. 4). The conveyor feed hopper 76 is accessible to the discharge chute systems with the chute systems in the folded configuration as shown in the figures.

As best seen in FIG. 5, and with reference to mixing drum 12, it being understood that mixing drum 14 is provided with identical operative parts, each mixing discharge system includes folding chute segments 80, 82 hinged at 84 and a chute drive or rotating system including a hydraulic cylinder 86 and operating pivot arm 88 which rotates a shaft 90 connected to a lockable pivot gear 92 in a well known manner. It should be understood that other systems such as hydraulic motors, or the like, can be used to operate the rotating chutes. Manual and/or automatic position locking devices and clutch release systems may also be provided. Such a system is illustrated and described in greater detail in U.S. Pat. No. 6,578,694 B2 to Harris et al, incorporated herein by reference for any purpose. An initial discharge chute section is shown at 94 which leads into the folding chutes 80, 82. A power unit is provided for each mixer at 96 and a hydraulic fluid storage tank is shown at 98.

As seen in FIG. 2, the barge is provided with a hand rail 100 which extends about the periphery of the deck. All platforms and stairways are also suitably provided with safety grating and hand rails.

As can best be seen in FIG. 4, note that the chute of mixer 12 is unfolded and rotated so that it now drains into the gray water sump 38. This posture, of course, is one used during a cleanout cycle for the mixing drum. The discharge chute system of drum 14 is similarly situated for cleanout.

In operation, ingredients to be mixed are loaded from a batching plant by equipment such as cantilevered conveyors, not situated on the barge, but which overhang the barge where it is pulled alongside into the drums for mixing including Portland cement, aggregate and water and any additives desired for a particular batch. Common additives may be kept in the additive totes or bins 34 which may be conveniently connected with the charging hoppers via hoses and pumps or the additives desired may be apportioned from the bins or totes and added by directly dumping into the charging chutes. After sufficient mixing takes place while the barge is positioning itself or being positioned at the desired location with relation to the pour site, the mixed drum load or loads can be discharged onto conveyor 16 and, in turn, conveyor 20 and thereafter off loaded using the chute system 32 in a well known manner.

An aspect of the invention previously mentioned, lies in the fact that control of the mixing and discharge of the materials and other operations can be conducted remotely from the control room utilizing remote cameras and a common central control system. It should further be realized that the batches in the batch and drum 12 may or may not match the batch in drum 14 and they can be discharged simultaneously or sequentially under the control of an operator. Thus, if desired, two different mixes of concrete can be provided at the job site for sequential pouring. Also, while the drums 12 and 14 are shown in an opposed back-to-back arrangement. Other arrangements including side-by-side could be used keeping in mind the load balancing and other concerns of the vessel and loading and distribution systems.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A vessel-mounted concrete mixing system comprising:
(a) at least one rotary mixing drum adapted to receive mix and discharge concrete batch ingredients; and
(b) a conveyor system situated to receive mixed concrete material discharge from said one or more rotary mixing drums and convey said mixed concrete material to a location on said barge accessible by an off-loading device not situated on said barge.

2. A vessel-mounted concrete mixing system comprising:
(a) a vessel having a deck elevated above the water line;
(b) at least one rotary mixing drum mounted on said deck to receive, mix and discharge concrete batch ingredients; and
(c) a conveyor system for conveying mixed concrete batch material discharged from said one or more rotary mixing drums, said conveyor system conveying said discharge mixed concrete to a portion of said barge accessible by an off-loading device not mounted on said barge.

3. A vessel-mounted concrete mixing system as in claim 1 further comprising a pair of opposed rotary mixing drums disposed to discharge mixed concrete batch ingredients onto a common conveyor.

4. A vessel-mounted concrete mixing system as in claim 2 further comprising a pair of opposed rotary mixing drums disposed to discharge mixed concrete batch ingredients onto a common conveyor.

5. A vessel-mounted concrete mixing system as in claim 2 further comprising an elevated platform and a controllable discharge chute system at the end of said conveyor system for off loading mixed concrete material.

6. A vessel-mounted concrete mixing system as in claim 2 wherein said conveyor system includes a pair of conveyors including a first conveyor which feeds discharged mixed concrete material to a second conveyor wherein said second conveyor has an elevated mechanized discharge chute.

7. A vessel-mounted concrete mixing system as in claim 2 further comprising rotating discharge chute systems connected to said one or more mixing drums, said chute systems being capable of operating between discharge and cleanout positions.

8. A vessel-mounted concrete mixing system as in claim 7 wherein said rotating chute systems discharge into a gray water sump in the cleanout position.

9. A vessel-mounted concrete mixing system as in claim 2 wherein said conveyor system further comprises a generally level first conveyor for receiving the output of said one or more rotary concrete mixing drums, said first conveyor, in turn, discharging onto a second conveyor having an elevated head pulley which leads to a controllable output chute for off-loading said mixed concrete.

10. A vessel-mounted concrete mixing system as in claim 9 wherein said first conveyor further includes a conveyor feed hopper mounted above said conveyor for receiving material discharged from said one or more mixing drums and a drip pan located beneath said conveyor for catching any spillage, wherein said drip pan drains into a water sump.

11. A vessel-mounted concrete mixing system as in claim 2 comprising a control system including means for controlling the operation of said one or more rotary concrete mixing drums and said conveyor system.

12. A vessel-mounted concrete mixing system as in claim 11 comprising a control system further including controls for operating associated swivel-mounted discharge chutes.

13. A vessel-mounted concrete mixing system as in claim 1 wherein said vessel is a barge.

14. A vessel-mounted concrete mixing system as in claim 2 wherein said vessel is a barge.

15. A method of supplying mixed concrete from a water borne vessel comprising the steps of:
(a) providing a vessel-mounted concrete mixing system as in claim 2;
(b) supplying said vessel with ingredients to be mixed; and
(c) off-loading mixed concrete from said vessel.

16. A vessel-mounted concrete mixing system as in claim 1 wherein said control system is operated from a control location.

17. A vessel-mounted concrete mixing system as in claim 12 wherein said control system is operated from a control location.
